(19) United States
(12) Patent Application Publication
(10) Pub. No.: US 2012/0184147 A1
(43) Pub. Date: Jul. 19, 2012

(54) ELECTRICAL CONNECTOR HAVING SMALL SIZE

(75) Inventors: JIAN-FEI YU, Kunshan (CN); QI-JUN ZHAO, Kunshan (CN)

(73) Assignee: HON HAI PRECISION INDUSTRY CO., LTD., New Taipei (TW)

(21) Appl. No.: 13/349,585

(22) Filed: Jan. 13, 2012

(30) Foreign Application Priority Data
Jan. 19, 2011 (CN) 201120017024.X

(51) Int. Cl. H01R 24/00

(52) U.S. Cl. 439/630

(57) ABSTRACT

A card connector (100) includes an insulative housing (1) and a number of conductive contacts (2) retained in the insulative housing (1). Each conductive contact (2) has a retaining portion (21) and a contacting portion (25) located in front of the retaining portion (21). The insulative housing (1) has a protrusion (131) extending upwardly. The retaining portion (21) has a confronting portion (26) engaging with the protrusion (131). Each contact (2) also has a soldering portion (24) extending from a rear end of the retaining portion (21), the soldering portion (24) is located under the retaining portion (21). The insulative housing (1) is sandwiched between the retaining portion (21) and the soldering portion (24) along a top to bottom direction. Therefore, the size of the card connector (100) is reduced.

### BACKGROUND OF THE INVENTION

1. Field of the Invention

The present invention generally relates to a card connector and more particularly to a card connector having small size.

2. Description of Related Art

China patent issue No. CN201638987U, issued on Nov. 17, 2010, discloses a conventional card connector including an insulative housing, a plurality of contacts retained in the insulative housing and a shell attached to the insulative housing. A receiving cavity is formed between the insulative housing and the shell. The contacts have a plurality of retaining portions mounted on the insulative housing, a plurality of resilient contacting portions extending forwardly into the receiving cavity from the retaining portions and a plurality of soldering portions extending backwardly from the retaining portions. A plurality of mounting holes are recessed on a back side of the insulative housing for retaining the retaining portiona. A plurality of lance barbs are set in two sides of the retaining portion and abut against the inner sides of the mounting hole. The retaining portion further has a fitting portion protruding from a bottom thereof to engage with the insulative housing. However, the lance barbs set in two sides of the retaining portion makes the structure of the contact complex and not easy to be assembled to the insualtive housing. The soldering portion and the resilient portion which extend from opposite of the retaining portion and project beyond the insulative housing make the size of the card connector lager.

It is thus desired to provide a card connector having small size.

### SUMMARY OF THE INVENTION

According to one aspect of the present invention provides a card connector comprising an insulative housing and a plurality of conductive contacts retained in the insulative housing. Each contact has a retaining portion and a contacting portion extending forwardly from a end of the retaining portion. The insulative housing comprises a plurality of fitting portions extending along a top-to-bottom direction, the retaining portion has a confronting portion abutting against the fitting portion in a front to back direction. The contact further comprise a soldering portion extending backwardly from another end of the retaining portion and located under the retaining portion to clamp the insulative housing cooperatively with the retaining portion.

According to another aspect of the present invention provides a card connector comprising an insulative housing, a shell covering the insulative housing and a plurality of conductive housing. The insulative housing has a plurality of first receiving cavities and a plurality of second receiving cavities located in front of the first receiving cavities and a plurality of notches depressed upwardly from the bottom of the insulative housing and located below the first receiving cavity. The depth of the second receiving cavity is deeper than that of the first receiving cavity. A receiving space defined between the shell and the insulative housing and communicating with the first and second receiving cavities. Each contact comprising a retaining portion received in the first receiving cavity, an extending portion extending forwardly from the retaining portion and received in the second receiving cavity, a contacting portion protruding into the receiving space from a front of the extending portion and a soldering portion received in the notch, the extending portion can move in the second receiving cavity along an up to down direction, the contacting portion extending upwardly and backwardly to protruding into the receiving space to connect with an electric card.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is an assembled perspective view of a card connector according to a preferred embodiment of the present invention;

FIG. 2 is another assembled perspective view of the card connector as shown in FIG. 1 taken from another view;

FIG. 3 is an exploded perspective view of the card connector;

FIG. 4 is another exploded perspective view of the card connector, while taken from a different aspect;

FIG. 5 is a cross-sectional view of the card connector taken along line 5-5 of FIG. 1.

### DETAILED DESCRIPTION OF THE INVENTION

Reference will now be made to the drawing figures to describe the preferred embodiment of the present invention in detail.

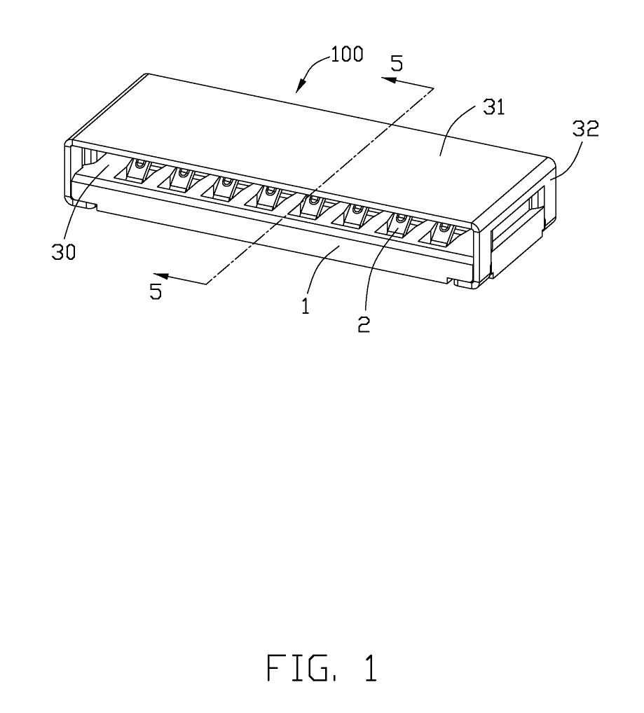

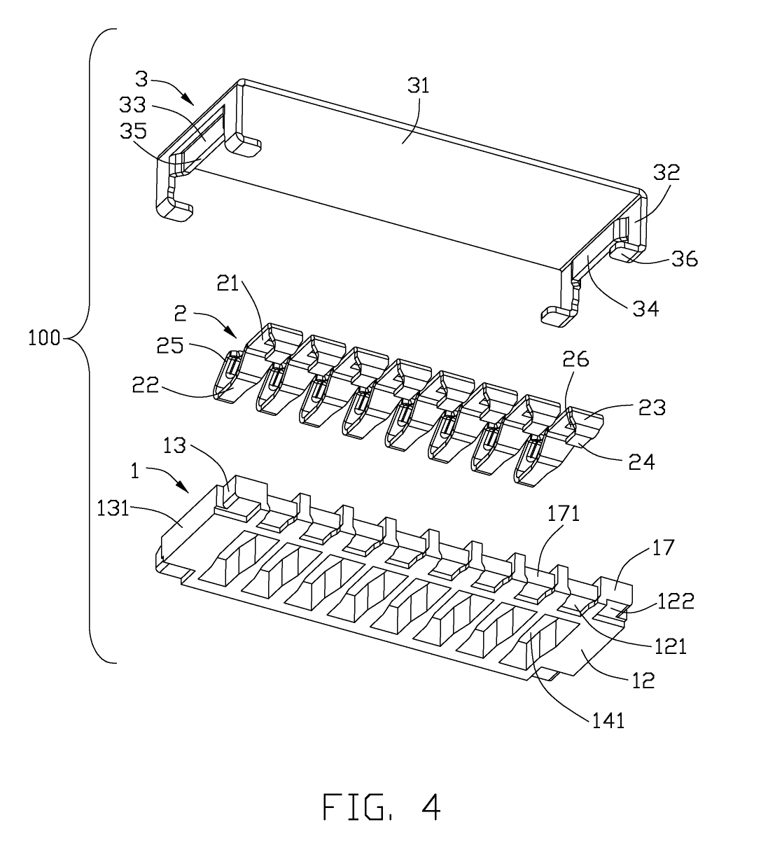

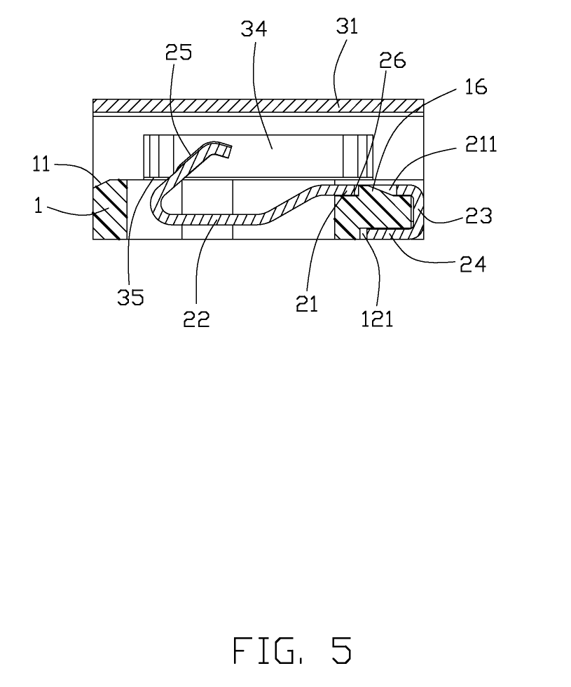

Referring to FIGS. 1-5, a card connector 100 includes an insulative housing 1, a plurality of conductive contacts 2 mounted on the insulative housing 1 and a shell 3 enclosing the insultive housing 1.

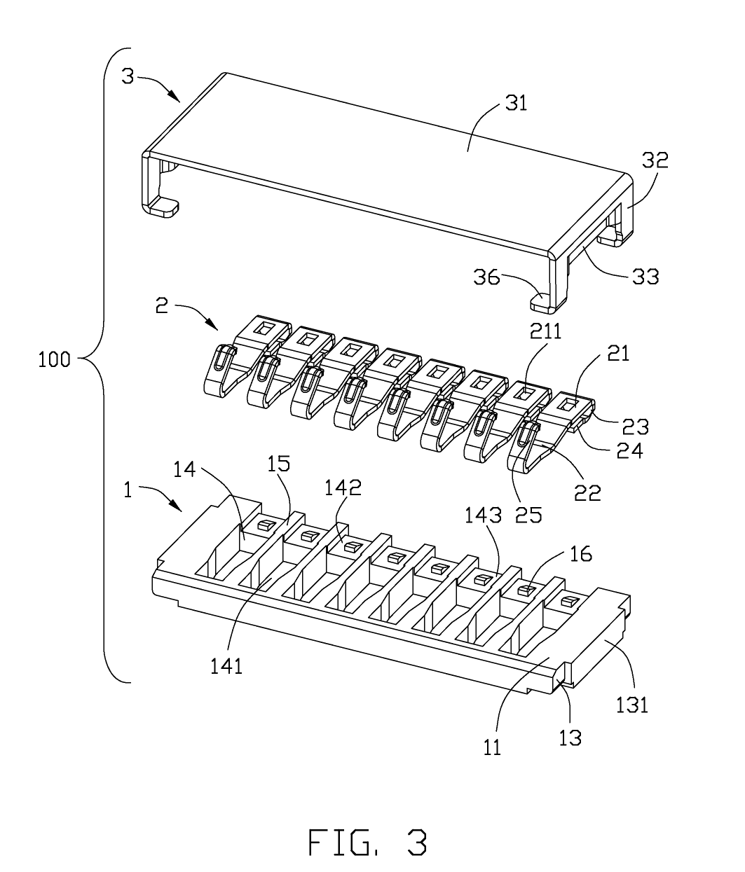

Please referring to FIGS. 3-5, the insulative housing 1 has a top surface 11, a bottom face 12, a pair of side surfaces 13 connecting the top surface 11 and the bottom face 12, and a back end face 17. A plurality of receiving passageways 14 are depressed downwardly from the top surface 11 for receiving the conductive contacts 2, and a plurality of traverse portions 15 are arranged between adjacent receiving passageways 14. The receiving passageways 14 comprise a plurality of first receiving cavities 142 located in a back of the insulative housing 1 and a plurality of second receiving cavities 141 located in a front of the insulative housing 1. A depth of the second receiving cavity 141 is deeper than that of the first receiving cavity 142. The second receiving cavities 141 extend through the top surface 11 and the bottom face 12. The first receiving cavity 142 comprises a bottom wall 143 and a fitting portion 16 protruding upwardly from the bottom wall 143 of the insulative housing 1.

The insulative housing 1 has a pair of protrusions 131 laterally protruding from the side surfaces 13, a plurality of receiving grooves 171 depressing from the back end face 17 and located between adjacent traverse portions 15, and a plurality of notches 121 located under the bottom wall 143 and depressing upwardly from the bottom face 12. The receiving groove 171, the receiving passageway 14 and the notch 121 communicate with each other and are aligned with each other. A plurality of locking recesses 122 are recessed upwardly from four corners of the bottom face 12 to engage with the shell 3.

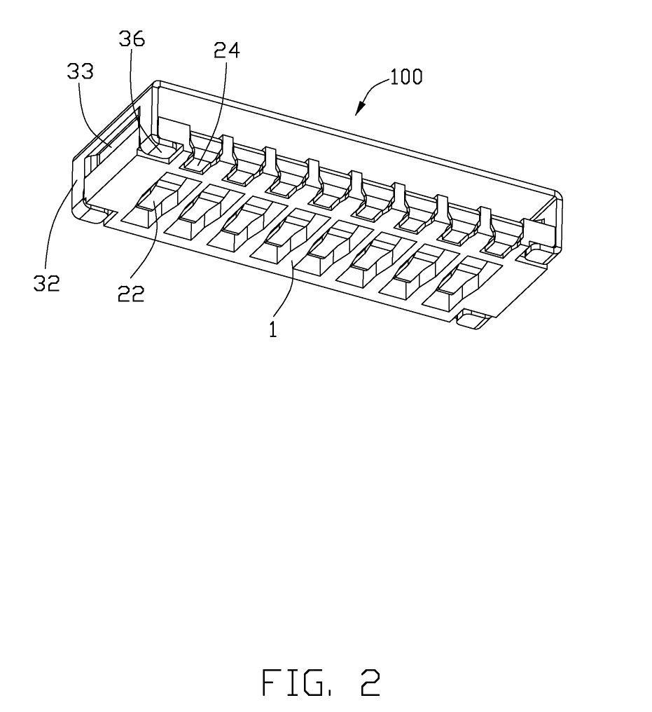

Please reference to FIGS. 2-5, the conductive contact 2 comprises a retaining portion 21 retained in the first receiving cavity 142, an extending portion 22 extending forwardly from a front of the retaining portion 21 and received in the second receiving cavity 141, a soldering portion 24 extending forwardly from a back of the retaining portion 21 and received in the notch 121, and a connecting portion 23 connecting the soldering portion 24 and the retaining portion 21. The soldering portion 24 is located below the retaining portion 21. The contact 2 also has a contacting portion 25 extending backwardly from a front end of the extending portion 22, the contacting portion 25 can move in the second receiving cavity 141 along an upper-to-lower direction. By this arrangement, the elastic properties of the contacting portion 25 can be increased. The retaining portion 21 has a through hole 211 extending therethrough along a top to bottom direction to lock and surround the fitting portion 16. A confronting portion 26 engaging backwardly with the fitting portion 16 is formed at a front edge of the through hole 211. The contact 2 is assembled in the insulative housing 1 along a back-to-front direction, the confronting portion 26 abuts against the fitting portion 16 to prevent the contacts 2 from moving backwardly. The connecting portion 23 is positioned by the adjacent traverse portion 15 along a left-to-right direction and received in the receiving groove 171 of the insulative housing 1 to prevent the contacts 2 from moving forwardly. The retaining portion 21 and the soldering portion 24 form an U shape configuration and clamp the insulative housing 1 along the top to bottom direction. By this arrangement, the contact 2 is simple in structure and easy to be installed into the insulative housing 1.

Please reference to FIGS. 1-4, the shell 3 comprises a top wall 31 and a pair of side walls 32 extending form two sides of the top wall 31. A receiving space 30 defined between the top surface 11 of the insulative housing 1 and the top wall for receiving an electric card (not shown). The receiving space 30 communicates with the first and the second receiving cavities 142, 141. The side wall 32 further comprises a limiting portion 33 extending into the receiving space 30 for abutting against with the top surface 11 of the insulative housing 1. The limiting portion 33 is formed by tearing the side wall 32 from an intermediate thereof, a front and a rear sides of the limiting portion 33 still connect with the side wall 32, and an upper and a lower sides of the limiting portion 33 are separated from the side wall 32. Each side wall 32 comprises a pair of horizontal latching arms 36 set in a front and a rear ends thereof, the latching arm 36 extending inwardly to lock with the insulative housing 1, the limiting portion 33 is located between the two latching arms 36 in a front-to-back direction and has a limiting planar surface 34 facing the receiving space 30 for positioning the electric card. A bottom surface 35 of the limiting portion 33 abuts against the top surface 11 downwardly and the latching arms 36 received in the notches 121 of the bottom face 12, in this arrangement, the insulative housing 1 is positioned in the shell 3 stationary. The latching arms 36 located at one side of the insulative housing 1 abuts against with a front and a back sides of the protrusion 131 in a transverse direction of the insulative housing 1 to prevent the insulative housing 1 from a front-to-back movement. An outside surface of the latching arm 36 and an outside face of the protrusion 131 are coplanar.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A card connector comprising:
an insulative housing having a plurality of fitting portions protruding along a top-to-bottom direction; and
a plurality of contacts retained to the insulative housing, each contact comprising a retaining portion, an extending portion extending forwardly from a front of the retaining portion, and a soldering portion extending forwardly from a back end of the contact, the retaining portion having a confronting portion engaging with the fitting portion to limit the contacts along a front to back direction; and the soldering portion located under the retaining portion to clamp the insulative housing cooperatively with the retaining portion.

2. The card connector as claimed in claim 1, wherein the fitting portions protrude upwardly from a rear of the insulative housing, the retaining portions define a plurality of through holes to lock and surround the fitting portions, the confronting portions are located at a front of the through holes and backwardly abut against the fitting portions.

3. The card connector as claimed in claim 2, wherein the insulative housing has a top surface, a bottom face and a first receiving cavity depressing from the top surface and located at the rear of the insulative housing, the retaining portion is received in the first receiving cavity, the fitting portion protrudes upwardly from the bottom of the first receiving cavity.

4. The card connector as claimed in claim 3, wherein each contact comprises a connecting portion connecting the retaining portion and the soldering portion along an upper-to-lower direction.

5. The card connector as claimed in claim 4, wherein the insulatve housing further has a back end face connecting the top surface and the bottom face and a plurality of receiving grooves depressing forwardly from the back end face, the connecting portions are received in the receiving grooves.

6. The card connector as claimed in claim 5, wherein the insulative housing has a plurality of traverse portions rested in two adjacent first receiving cavities, the traverse portions extend backwardly and downwardly to separate the adjacent receiving grooves.

7. The card connector as claimed in claim 6, wherein the insulative housing further comprises a plurality of notches depressed upwardly from the bottom face and communicating with the receiving grooves, the soldering portions extend forwardly and are received in the notches.

8. The card connector as claimed in claim 3, further comprising a shell, the shell comprises a top wall, and two side walls extending from two side of the top wall, a receiving cavity is defined between the top surface of the insulative housing and the top wall of the shell.

9. The card connector as claimed in claim 8, wherein the side wall has a limiting portion extending into the receiving cavity and abutting against the top surface downwardly.

10. The card connector as claimed in claim 2, wherein the contact has a contacting portion extending upwardly and backwardly from a rear of the extending portion.

11. A card connector adapted for connecting with an electrical card comprising:
an insulative housing defining a first receiving cavity and a second receiving cavity located in a front of the first receiving cavity, a depth of the second receiving cavity being larger than that of the first receiving cavity, a notch depressed upwardly from the bottom of the back of the insulative housing and located under the first receiving cavity;
a shell enclosing the insulative housing to define a receiving space between the shell and the insulative housing, the receiving space communicating with the first and second receiving cavities;
a plurality of conductive contacts retained in the insulative housing, each contact comprising a retaining portion received in the first receiving cavity, an extending portion extending forwardly from the retaining portion and received in the second receiving cavity, a contacting portion protruding into the receiving space from a front of the extending portion and a soldering portion received in the notch, the extending portion movable in the second receiving cavity along upper-to-lower direction, the contacting portion extending upwardly and backwardly to protruding into the receiving space for connecting with the electric card.

12. The card connector as claimed in claim 11, wherein the conductive contact further has a connecting portion connecting with the retaining portion and the soldering portion, the insulative housing also comprises a receiving groove depressed forwardly from a back end surface thereof to receive the connecting portion.

13. The card connector as claimed in claim 12, wherein the first receiving cavity, the receiving groove and the notch communicate with each other, the soldering portion extends forwardly to be received in the notch.

14. The card connector as claimed in claim 13, wherein the insulative housing is positioned between the retaining portion and the soldering portion along a top-to-bottom direction.

15. The card connector as claimed in claim 12, wherein the insulative housing has a plurality of traverse portions rested in two adjacent first receiving cavities, the traverse portions extende backwardly and downwardly to separate the adjacent receiving grooves.

16. An electrical connector for mounting to a printed circuit board, comprising:
an insulative housing defining an upper mating face and a bottom mounting face opposite to each other in a vertical direction;
a metallic shell assembled upon the housing to shield the upper mating face in the vertical direction with a receiving cavity therebetween for receiving a card; and
a plurality of terminals disposed in the housing with contacting sections extending upwardly above the upper mating face and into the receiving cavity;
wherein
the terminals define defines a lying U-shaped configuration, including an upper horizontal retention arm positioned upon the upper mating face, and a lower horizontal soldering portion beneath the bottom mounting face, for securely sandwiching the housing.

17. The electrical connector as claimed in claim 16, wherein the housing defines plurality of passageways to receive the corresponding terminals, and said passageway extends through the housing in the vertical direction for allowing downward deflection of the contacting section during mating.

18. The electrical connector as claimed in claim 16, wherein the housing and the corresponding terminal are configured to have the terminal assembled into the corresponding passageway initially downwardly and successively forwardly instead of simply forwardly.

19. The electrical connector as claimed in claim 16, wherein an opening is formed in the upper horizontal retention arm of the lying U-shaped configuration to receive a wedge formed on the upper mating face of the housing so as to secure the terminal to the housing without rearward withdrawal.
